(19) United States
(12) Patent Application Publication
(10) Pub. No.: US 2006/0112732 A1
(43) Pub. Date: Jun. 1, 2006

(54) Method and apparatus for heating porous preform

(75) Inventors: Jae-Hoon Jin, Gumi-si (KR); Jin-Han Kim, Gumi-si (KR); Yeong-Seop Lee, Gumi-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/222,120

(22) Filed: Sep. 8, 2005

(30) Foreign Application Priority Data
Nov. 26, 2004 (KR) 2004-98178

(51) Int. Cl. C03B 37/012

(52) U.S. Cl. 65/426; 65/507; 65/530

(57) ABSTRACT

A method for heating a porous preform according to the present invention comprises the steps of accommodating the porous preform in a muffle tube, forming a high temperature zone on a portion of a moving path of the muffle tube, using a heater and moving the muffle tube along the moving path to pass through the high temperature zone.

### CLAIM OF PRIORITY

This application claims the benefit of the earlier patent application entitled “A Method for Heating a Porous Preform,” filed in the Korean Intellectual Property Office on Nov. 26, 2004 and assigned Serial No. 2004-98178, the contents of which are hereby incorporated by reference.

### BACKGROUND OF THE INVENTION

1. Field of the Invention

The present invention relates to manufacturing an optical fiber preform, and more particularly, to a method and an apparatus for heating a porous preform.

2. Description of the Related Art

In order to obtain an optical fiber preform by dehydrating and sintering a porous preform which is manufactured through a vapor axial deposition (VAD) process or an outside vapor deposition (OVD) process, it is necessary to implement heat treatment for the porous preform under atmospheric gas such as chlorine, oxygen, helium, and so forth. Devices or apparatus for implementing heat treatment are well known and have been disclosed in the art, an example of which is described in U.S. Pat. No. 6,748,766. More specifically, U.S. Pat. No. 6,748,766 issued to Kohmura and entitled “Porous Preform Vitrification Apparatus”, describes that a porous preform is accommodated in a furnace core tube, and the furnace core tube is filled with atmospheric gas. The porous preform is sintered using a heating furnace which is arranged around the furnace core tube.

FIG. 1 is a view illustrating a typical apparatus for sintering a porous preform. The sintering apparatus 100 includes a transfer device 130, a muffle tube 140 and a furnace 150.

A porous preform 120 is deposited on a first end of a seed rod 110.

The transfer device 130 includes a base 132, a vertical support member 134 which extends vertically upwards from the base 132, a horizontal support member 136 which extends horizontally from the vertical support member 134, and a chuck 138 which is installed on a distal end of the horizontal support member 136. A second end of the seed rod 110 is fastened to the chuck 138. In the transfer device 130, the horizontal support member 136 can be vertically moved along the vertical support member 134 to vertically move the porous preform 120.

The muffle tube 140 defines a cylindrical chamber. The muffle tube 140 is defined, through an upper wall thereof, with a hole 142 through which the seed rod 110 can pass. Adjacent to upper and lower ends of the muffle tube 140, the muffle tube 140 is defined with an outlet port 144 and an inlet port 146, respectively. Atmospheric gas may be introduced into the muffle tube 140 through the inlet port 146 and can be discharged out of the muffle tube 140 through the outlet port 144. The porous preform 120 is suspended in the muffle tube 140, and the seed rod 110 on which the porous preform 120 is deposited passes through the hole 142 of the muffle tube 140.

The furnace 150 possesses a hollow cylindrical configuration and has a ring-shaped heater 160 disposed therein. The muffle tube 140 is fitted in the furnace 150 so that the heater 160 is arranged around the muffle tube 140.

Hereafter, a method for sintering the porous preform 120 using the sintering apparatus 100 will be described.

First, the porous preform 120 is accommodated in the muffle tube 140.

Second, atmospheric gas is introduced into the muffle tube 140 through the inlet port 146.

Third, a high temperature zone of no less than 1,500° C. is formed in the muffle tube 140 using the heater 160.

Fourth, the porous preform 120 is vertically moved by the transfer device 130 to pass through the high temperature zone.

As described above, the conventional method for sintering a porous preform adopts a zone sintering scheme in which sintering is implemented while the porous preform passes through the high temperature zone formed in the muffle tube. Due to this fact, a muffle tube having a length at least two times greater than that of the porous preform is needed. Also, due to the substantial length of the muffle tube, a great amount of atmospheric gas must necessarily be used.

### SUMMARY OF THE INVENTION

Accordingly, the present invention has been made to solve the above-mentioned problems occurring in the prior art, and an object of the present invention is to provide a method for heating a porous preform which can decrease the size of a muffle tube and reduce the amount of atmospheric gas needed when compared to the conventional art.

In order to achieve the object, according to one aspect of the present invention, there is provided a method for heating a porous preform, comprising the steps of (a) accommodating the porous preform in a muffle tube, (b) forming a high temperature zone along a moving path of the muffle tube using a heater, and (c) moving the muffle tube along the moving path to pass through the high temperature zone.

According to another aspect of the present invention, there is provided a method for heating a porous preform, comprising the steps of (a) accommodating the porous preform in a muffle tube; (b) forming a first high temperature zone along a moving path of the muffle tube using a first heater, (c) placing the muffle tube in the first high temperature zone and dehydrating the porous perform, (d) forming a second high temperature zone on the moving path of the muffle tube using a second heater, and (e) moving the muffle tube along the moving path to pass through the second high temperature zone and sintering the porous preform.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a typical apparatus for sintering a porous preform;

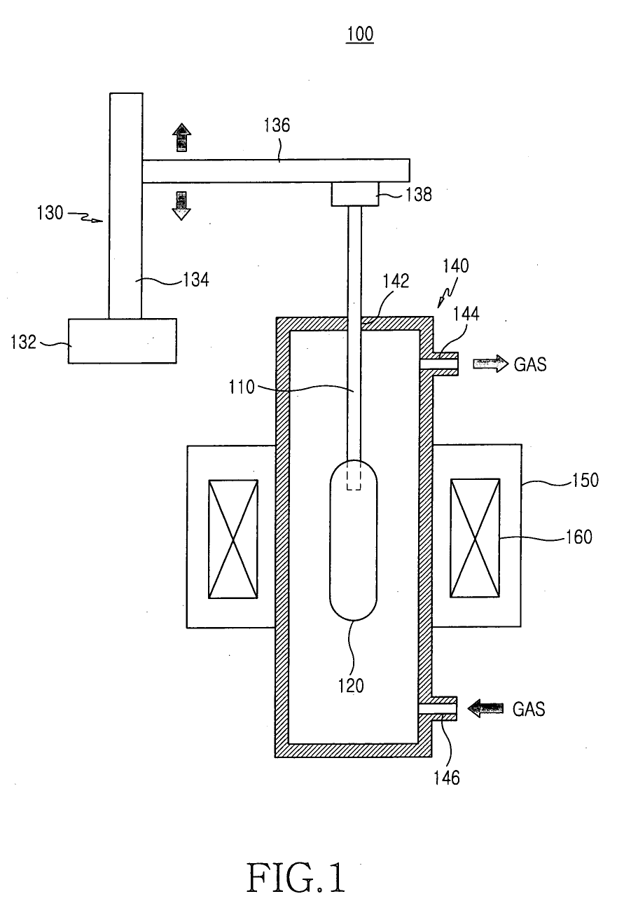

FIG. 2 is a view illustrating an apparatus for heating a porous preform in accordance with a first embodiment of the present invention;

FIG. 3 is a view illustrating a fixing member shown in FIG. 2; and

FIG. 4 is a view illustrating a state in which a muffle tube shown in FIG. 2 is moved downward.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

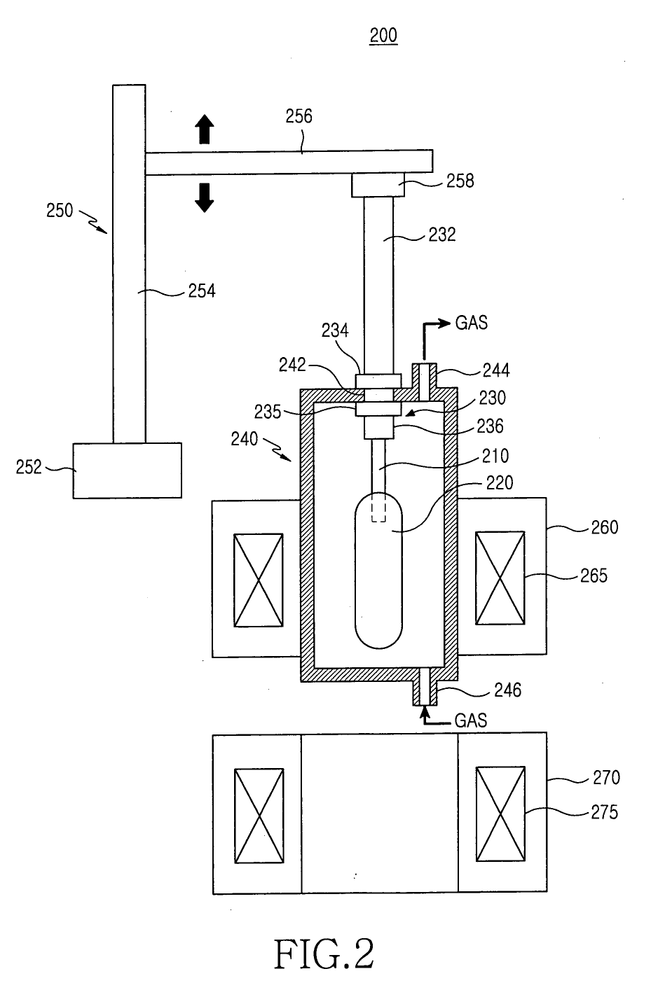

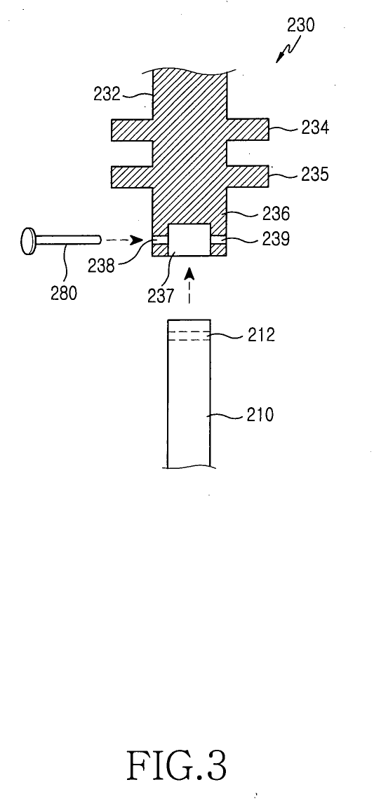

FIG. 2 is a view illustrating an apparatus for heating a porous preform in accordance with an embodiment of the present invention; and FIG. 3 is a view illustrating, in more detail, a fixing member shown in FIG. 2. The heating apparatus 200 includes a transfer device 250, a muffle tube 240, a fixing member 230, and first and second furnaces 260 and 270.

A porous preform 220 is deposited on a first end of a seed rod 210 which has a circular rod-shaped configuration. A hole 212 is defined through an upper end of the seed rod 210 to extend in a diametrical direction (see FIG. 3). An exemplary method for forming the porous preform 220 by a vapor axial deposition process will be described below.

By injecting a flame toward a center of a seed rod using a first burner, a core layer made of pure silica material grows downward. Fuel and raw material are supplied into the first burner. As a result, a core layer is deposited on an end of the seed rod through flame injection. As the raw material, a compound of SiCl₄, GeCl₄, POCl₃, and so forth, can be, and is conventionally, employed. By injecting a flame toward a circumferential outer surface of the core layer using a second burner, a clad layer made of silica material which is doped with a refraction index controlling material is deposited. Fuel and raw material are supplied into the second burner. As a consequence, the clad layer is deposited on the circumferential outer surface of the core layer through flame injection.

The muffle tube 240 defines a cylindrical chamber. The muffle tube 240 is defined, through an upper wall thereof, with a hole 242 through which the fixing member 230 is mounted to the upper wall and an outlet port 244 which is spaced apart from the hole 242. The muffle tube 240 is defined, through a lower wall thereof, with an inlet port 246. The outlet port 244 is connected with a discharge pipe (not shown), and the inlet port 246 is connected with an introduction pipe (not shown). Atmospheric gas is introduced through the inlet port 246 into the muffle tube 240 and discharged out of the muffle tube 240 through the outlet port 244. The porous preform 220 is accommodated in the muffle tube 240. The seed rod 210 on which the porous preform 220 is deposited is fixed with respect to the upper wall of the muffle tube 240.

FIG. 3 illustrates in further detail of the means for retaining seed rod 210 at a fixed distance from the upper wall of muffle tube 240. The fixing member 230 includes a circular rod-shaped body 232, circular ring-shaped first and second flanges 234 and 235 which extend radially outwards from a circumferential outer surface of the body 232 and are spaced apart from each other, and a connector 236 which axially extends from the body 232 and has a circular rod-shaped configuration when viewed in its entirety. The body 232, the first and second flanges 234 and 235 and the connector 236 are formed integrally with one another.

The connector 236 has a circular groove 237 defined at a distal end thereof. The circular groove 237 has a predetermined depth. A sidewall portion of the connector 236, which delimits the circular groove 237, is defined with first and second holes 238 and 239 which are aligned in line. The upper end of the seed rod 210 is received in the groove 237 of the connector 236. By inserting a pin 280 to pass through the first and second holes 238 and 239 of the connector 236 and the hole 212 of the seed rod 210, the seed rod 210 is fixed with respect to the fixing member 230. A body portion between the first and second flanges 234 and 235 is fitted through the hole 242 of the muffle tube 240, as a result of which the fixing member 230 is securely mounted to the muffle tube 240.

Returning to FIG. 2, the transfer device 250 includes a base 252, a vertical support member 254 which extends vertically upwards from the base 252, a horizontal support member 256 which extends horizontally from the vertical support member 254, and a chuck 258 which is installed on a distal end of the horizontal support member 256. An upper end of the fixing member 230 is fastened to the chuck 258. In the transfer device 250, by vertically moving the horizontal support member 256, the muffle tube 240 can be moved in a vertical direction. This type of transfer devices have been disclosed in the art. As an example, in U.S. Pat. No. 6,053,013 entitled “Apparatus and Method for Overcladding Optical Fiber Preform Rod and Optical Fiber Drawing Method”, a transfer device includes a base, a vertical support member which extends vertically upwards from the base, a horizontal support member which extends horizontally from the vertical support member, and a chuck which is installed on a distal end of the horizontal support member. The horizontal support member can be vertically moved along the vertical support member.

The first furnace 260 has a hollow cylindrical configuration and has a first ring-shaped heater 265 disposed therein. The first furnace 260 is arranged around a moving path of the muffle tube 240 to radiate heat toward the moving path of the muffle tube 240. The first furnace 260 is used for a dehydrating purpose, and forms therein a first high temperature zone of about 1,100° C.

The second furnace 270 has a hollow cylindrical configuration and has a second ring-shaped heater 275 disposed therein. The second furnace 270 is also arranged around the moving path of the muffle tube 240 to radiate heat toward the moving path of the muffle tube 240. The second furnace 270 is used for a sintering purpose, and forms therein a second high temperature zone of no less than 1,500° C.

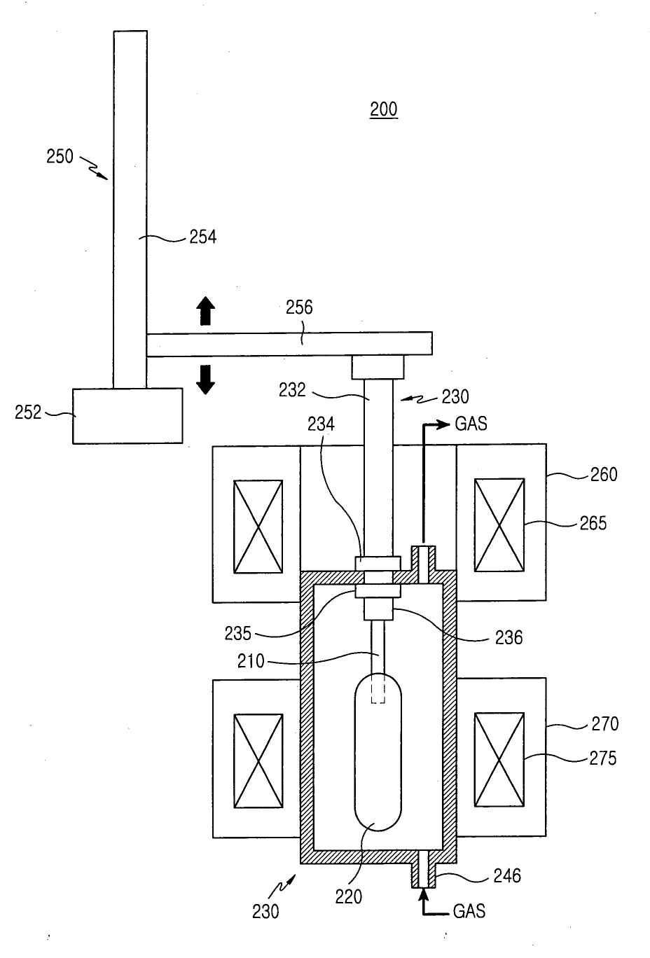

FIG. 4 is a view illustrating a state in which the muffle tube 240 shown in FIG. 2 is moved downward. Hereafter, a method for heating the porous preform 220 according to the present invention will be described with reference to FIGS. 2 through 4.

(a) Initially, in a state in which the muffle tube 240 is positioned above the first furnace 260, the porous preform 220 is accommodated in the muffle tube 240;

(b) The atmospheric gas is introduced into the muffle tube 240 through the inlet port 246;

(c) The first high temperature zone of about 1,100° C. is formed using the first heater 265 in the first furnace 260 which is located around and along the moving path of the muffle tube 240;

(d) The muffle tube 240 is moved downwards by the transfer device 250 into the interior of the first furnace 260 so that the muffle tube 240 is positioned in the first high temperature zone;

(e) The second high temperature zone of no less than 1,500° C. is formed using the second heater 275 in the second furnace 270 which is located around and along the moving path of the muffle tube 240;

(f) When a dehydrating process is completed, the muffle tube 240 is moved downwards by the transfer device 250 at a low speed of in the range of 3-10 mm/min so that the muffle tube 240 passes through the second high temperature zone; and

(g) After a sintering process is completed, the porous preform 220 is removed from the muffle tube 240.

As is apparent from the above description, the method for heating a porous preform according to the present invention provides advantages in that, since a muffle tube moving scheme is adopted, it is possible to significantly decrease a size of a muffle tube and reduce an amount of atmospheric gas when compared to the conventional art.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for heating a porous preform, comprising the steps of:
(a) accommodating the porous preform in a muffle tube;
(b) forming a high temperature zone around and along a portion of a moving path of the muffle tube using a heater; and
(c) moving the muffle tube along the moving path to pass through the high temperature zone.

2. The method according to claim 1, wherein, during the step of moving the muffle tube, an atmospheric gas is included in the muffle tube.

3. The method according to claim 1, wherein the high temperature zone has a temperature of no less than 1,500° C.

4. The method according to claim 1, wherein the muffle tube is moved in the high temperature zone at a speed in the range of 3 to 10 mm/min.

5. A method for heating a porous preform, comprising the steps of:
(a) accommodating the porous preform in a muffle tube;
(b) forming a first high temperature zone around and along a portion of a moving path of the muffle tube, using a first heater;
(c) moving the muffle tube in the first high temperature zone and dehydrating the porous preform;
(d) forming a second high temperature zone around and along a portion of the moving path of the muffle tube using a second heater; and
(e) moving the muffle tube along the moving path to pass through the second high temperature zone and sintering the porous preform.

6. The method according to claim 5, wherein, during the steps of moving the muffle tube in the first and second temperature zones, an atmospheric gas is filled in the muffle tube.

7. The method according to claim 5, wherein the first high temperature zone has a temperature of no less than 1,100° C.

8. The method according to claim 5, wherein the second high temperature zone has a temperature of no less than 1,500° C.

9. The method according to claim 5, wherein the muffle tube is moved in the second high temperature zone at a speed in the range of 3 to 10 mm/min.

10. An apparatus for heating a porous preform, comprising:
means for accommodating the porous preform in a muffle tube;
a heater for forming a high temperature zone along a portion of a moving path of the muffle tube; and
means for moving the muffle tube along the moving path to pass through the high temperature zone.

11. The apparatus according to claim 10, further comprising:
means for providing a gas into the muffle tube; and
means for discharging the gas from the muffle tube.

12. The apparatus according to claim 10, wherein the heater is positioned around the circumference of the muffle tube.

13. The apparatus according to claim 10, wherein the high temperature zone has a temperature of no less than 1,500° C.

14. The apparatus according to claim 10, wherein the muffle tube is moved in the high temperature zone at a speed in the range of 3 to 10 mm/min.

15. An apparatus for heating a porous preform, comprising:
means for accommodating the porous preform in a muffle tube;
a first heater forming a first high temperature zone along a portion of a moving path of the muffle tube;
a second heater forming a second high temperature zone along the moving path of the muffle tube; and
means for moving the muffle tube along the moving path to pass through the first high temperature zone for dehydrating the porous perform and the second high temperature zone and sintering the porous preform.

16. The apparatus according to claim 15, further comprising:
means for providing a gas into the muffle tube; and
means for discharging the gas from the muffle tube.

17. The apparatus according to claim 15, wherein the first high temperature zone has a temperature of no less than 1,100° C.

18. The apparatus according to claim 15, wherein the second high temperature zone has a temperature of no less than 1,500° C.

19. The apparatus according to claim 15, wherein the muffle tube is moved in each of the high temperature zones at a speed in the range of 3 to 10 mm/min.

20. The apparatus according to claim 15, wherein the first and second heaters are positioned around the circumference of the muffle tube.

21. An apparatus heating a porous preform, comprising:
means for accommodating the porous preform in a muffle tube;
a heater for forming a high temperature zone along a portion of a moving path of the muffle tube; and
means for moving the muffle tube along the moving path to pass through the high temperature zone.

22. The apparatus according to claim 21, further comprising:
means for providing a gas into the muffle tube; and
means for discharging the gas from the muffle tube.

23. The apparatus according to claim 21, wherein the heater is positioned around the circumference of the muffle tube.

24. The apparatus according to claim 21, wherein the high temperature zone has a temperature of no less than 1,100° C.

25. The apparatus according to claim 21, wherein the muffle tube is moved in the high temperature zone at a speed in the range of 3 to 10 mm/min.

26. The apparatus according to claim 21, further comprising:
a second heater for forming a second high temperature zone along a portion of the moving path of the muffle tube, the second heater being positioned around the circumference of the muffle tube wherein the muffle tube sequentially moves along the moving path to pass through the second high temperature zone.

27. The apparatus according to claim 26, wherein the second high temperature zone has a temperature of no less than 1,500° C.
